(19) United States
(12) Patent Application Publication
(10) Pub. No.: US 2015/0271463 A1
(43) Pub. Date: Sep. 24, 2015

(54) ADDING CONTENT TO A PROGRAM

(71) Applicant: Lockheed Martin Corporation, Bethesda, MD (US)

(72) Inventor: Edward J. Miesak, Windermere, FL (US)

(73) Assignee: Lockheed Martin Corporation, Bethesda, MD (US)

(21) Appl. No.: 14/222,164

(22) Filed: Mar. 21, 2014

(51) Int. Cl. H04N 13/00; G02B 27/26; G02B 27/28

(52) U.S. Cl. CPC H04N 13/007; G02B 27/286; G02B 27/26

(57) ABSTRACT

Mechanisms for adding content to a projected light stream are disclosed. A polarization rotation panel receives content and generates a polarization rotation pattern based on the content. The polarization rotation panel receives at least a first portion of a first projected light stream that has a first polarization orientation. The first polarization orientation of a sub-portion of the at least the first portion of the first projected light stream is rotated an offset amount to a first offset polarization orientation in accordance with the polarization rotation pattern, and the at least the first portion of the first projected light stream and the sub-portion are issued in a downstream direction.

### TECHNICAL FIELD

The embodiments relate to projected programs, such as movies, and in particular to adding content, such as subtitles, to a projected three-dimensional program.

### BACKGROUND

Many viewers find subtitles that are provided in a program, such as a television program, a movie, or a pay-per-view live program, to be distracting. Other viewers, such as a viewer who does not understand the language used in the program, need subtitles in order to understand the program. When a viewer watches a program in an environment controlled by the viewer, such as the viewer's home, the viewer may enable or disable subtitles as they wish. In some forums however, such as a movie theater, some viewers may desire to view subtitles, and other viewers may not. Some jurisdictions may soon require that subtitles be available to any viewer who desires to view subtitles. Thus, the operator of a movie theater may desire, or may even be obligated, to provide subtitles when presenting a movie to an audience.

The majority of projected programming today is two-dimensional (2D), and some subtitle-selectivity techniques exist that allow a viewer with polarized glasses to view subtitles, while other viewers of the same projected program who are not wearing the polarized glasses cannot see the subtitles. However, there is increasing interest in three-dimensional (3D) programming, and many believe 3D programming will someday become the standard. However, in order to properly view 3D programming, all the viewers must wear polarized glasses, rendering subtitle-selectivity mechanisms that are based on wearing or not wearing polarized glasses unsuitable for 3D programming.

### SUMMARY

The embodiments relate to mechanisms for adding content to a projected three-dimensional (3D) program. In one embodiment a method for providing subtitles in a projected 3D program is provided. A transparent polarization rotation panel is disposed in a path between a projector and a screen. The polarization rotation panel receives content, such as subtitles, and generates a polarization rotation pattern based on the content. A first portion of a first projected light stream having a first polarization orientation is received by the transparent polarization rotation panel. The first portion of the first projected light stream passes through the polarization rotation panel and the first polarization orientation of a sub-portion of the first portion is rotated an offset amount to a first offset polarization orientation in accordance with the polarization rotation pattern. The portion of the first projected light stream and the sub-portion are issued in a direction toward the screen.

In one embodiment, a viewer wears a pair of glasses that comprises a multi-layer lens. The multi-layer lens includes a first layer, a second layer, and a third layer. The first layer of the lens blocks a second projected light stream and passes a first projected light stream comprising a first portion of light having a first polarization orientation and a sub-portion of light having a first offset polarization orientation to the second layer of the lens. The second layer of the lens rotates a polarization orientation of the sub-portion of the first projected light stream from the first offset polarization orientation to a second offset polarization orientation. In some embodiments, the second offset polarization orientation is substantially orthogonal to the first polarization orientation. The second layer passes the first portion of the first projected light stream and the sub-portion to a third layer of the lens. The third layer of the lens blocks the sub-portion of the first projected light stream, and passes the first portion of the first projected light stream in a downstream direction toward an eye of a viewer. The eye of the viewer receives the first projected light stream absent the sub-portion. Because the sub-portion of the first projected light stream is determined based on the polarization rotation pattern, which in turn is based on the content, the viewer perceives the content by virtue of the absence of light in the pattern of the content. In one embodiment, the first projected light stream comprises a movie and the content comprises subtitles.

In one embodiment, the offset amount is an amount in a range between about 5 degrees to about 20 degrees with respect to the first polarization orientation. In one embodiment, the offset amount is an amount in a range between about 10 degrees to about 15 degrees with respect to the first polarization orientation.

In one embodiment, the transparent polarization rotation panel comprises an array of liquid crystal display (LCD) elements. At least some of the LCD elements have a non-rotation mode and a rotation mode. In one embodiment, the transparent polarization rotation panel iteratively receives new content, sets the LCD elements in the array to the non-rotation mode, determines a new group of LCD elements that form a new polarization rotation pattern based on the new content, and sets the LCD elements in the new group of LCD elements to the rotation mode. As new light from the first projected light stream passes through the LCD elements in the rotation mode that form the new polarization rotation pattern, the polarization orientation of such light is rotated an offset amount to the first offset polarization orientation.

In one embodiment, a transparent polarization rotation panel is provided. The transparent polarization rotation panel comprises an array of LCD elements. At least some of the LCD elements have a non-rotation mode and a rotation mode. The polarization rotation panel also includes a processor that is coupled to the array of LCD elements. The processor is configured to receive content, to determine a group of LCD elements that form a polarization rotation pattern based on the content, and to set the LCD elements in the group of LCD elements to the rotation mode.

In another embodiment, a multi-layer lens for a pair of glasses is provided. The multi-layer lens includes a first layer, a second layer, and a third layer. The first layer is configured to receive a first projected light stream that comprises a first portion of light having a first polarization orientation and a sub-portion of light having a first offset polarization orientation, and to receive a second projected light stream having a third polarization orientation. The first layer is further configured to block the second projected light stream, and pass the first projected light stream to the second layer of the lens. The second layer is configured to rotate a polarization orientation of the sub-portion of light from the first offset polarization orientation to a second offset polarization orientation and pass the first portion of light and the sub-portion of light to the third layer of the lens. The third layer is configured to block the sub-portion of light and pass the first portion of light in a downstream direction.

In another embodiment, a system is provided. The system includes a first projector that is configured to generate a first projected light stream having a first polarization orientation, and a second projector that is configured to generate a second projected light having a second polarization orientation. The system includes a transparent polarization rotation panel that comprises an array of LCD elements. At least some of the LCD elements have a non-rotation mode and a rotation mode. The system includes a content generator that is communicatively coupled to the polarization rotation panel. The polarization rotation panel receives content from the content generator, determines a group of LCD elements that form a polarization rotation pattern based on the content, and sets the LCD elements in the group of LCD elements to the rotation mode.

A portion of the first projected light stream having a first polarization orientation is received by the transparent polarization rotation panel. The portion of the first projected light stream passes through the polarization rotation panel, and the first polarization orientation of a sub-portion of the portion of the first projected light stream is rotated an offset amount to a first offset polarization orientation in accordance with the polarization rotation pattern. The portion of the first projected light stream and the sub-portion are issued in a direction toward a screen.

The screen reflects the first projected light stream and the second projected light stream in a direction toward a pair of glasses worn by a user. The glasses include a multi-layer lens that is configured to block the sub-portion, to block the second projected light stream, and to pass the remainder of the first projected light stream in a downstream direction.

Those skilled in the art will appreciate the scope of the disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of a system in which embodiments may be practiced during a first time period;

FIG. 2 is a flowchart of a method according to one embodiment;

FIG. 3 is a block diagram of the system illustrated in FIG. 1 during a second time period;

FIG. 4 is a flowchart of a method according to one embodiment;

FIG. 5 is a block diagram of a polarization rotation panel according to one embodiment;

FIGS. 6A and 6B are block diagrams illustrating two different embodiments of the polarization rotation panel;

FIG. 7 is a block diagram of a multi-layer lens of glasses according to one embodiment;

FIG. 8 is a block diagram of a system in which embodiments may be practiced according to a single projector embodiment; and

FIG. 9 is a block diagram of a system according to another embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first projected light stream” and “second projected light stream” and does not imply a priority, a type, an importance, or other attribute, unless otherwise stated herein.

The embodiments relate to mechanisms for introducing content, such as subtitles, into a projected three-dimensional (3D) program. The embodiments are applicable to any projected program, such as a movie, television, live, video-on-demand, and the like. The phrase “projected” refers to the projection of light a distance across free space toward a surface.

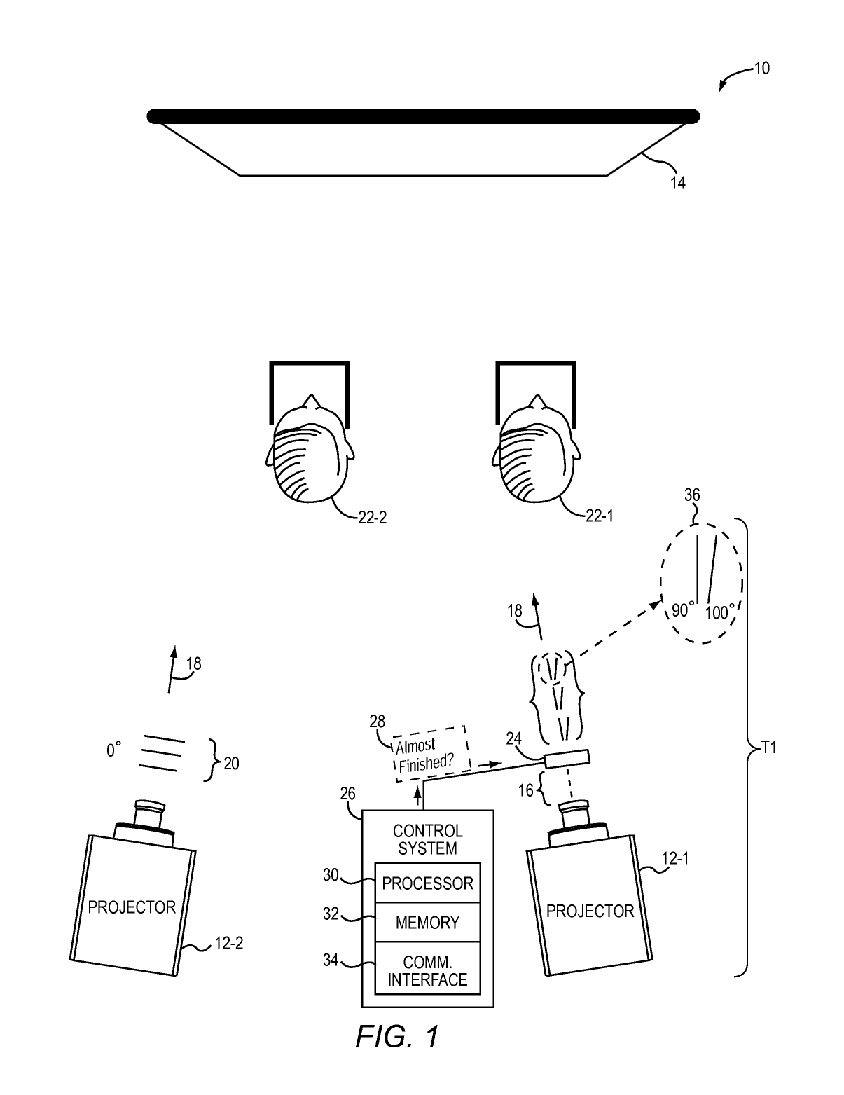

FIG. 1 is a block diagram of a system 10 in which embodiments may be practiced. The system 10 includes a projective system that includes a first projector 12-1 and a second projector 12-2 (generally, projectors 12). The projectors 12 project light toward a screen 14. The first projector 12-1 projects a first projected light stream 16 in a direction 18 toward the screen 14. The phrase “light stream” refers to a stream of light over a duration of time. The duration of time may be relatively brief, as in seconds, may be relative long, as in hours, or may be for an indefinite period of time. The first projected light stream 16 comprises the content of a program, such as a movie, a television program, a pay-per-event, or the like. The program may be provided to the first projector 12-1 for projection via one or more devices (not illustrated). The screen 14 preserves the polarization of the light that is reflected off the screen 14.

The second projector 12-2 concurrently projects a second projected light stream 20 in the direction 18 toward the screen 14. The second projected light stream 20 also comprises the content of the program, which may be provided to the second projector 12-2 for projection via the same one or more devices as those that provide the program to the first projector 12-1.

In order to provide a 3D effect to viewers 22-1 and 22-2 (generally, viewers 22), the first projected light stream 16 has a first polarization orientation and the second projected light stream 20 has a second polarization orientation. The polarization orientations may be provided by the projectors 12-1, 12-2, respectively, or may be provided by polarizers (not illustrated) subsequent to the output of the projectors 12-1, 12-2. The first polarization orientation is typically, but not necessarily, orthogonal to the second polarization orientation. Solely for purposes of discussion, the first polarization orientation will be discussed herein as a vertical orientation and be arbitrarily assigned an orientation of 90 degrees, and the second polarization orientation will be discussed herein as a horizontal orientation and be assigned an orientation of 0 degrees; however, the first polarization orientation and the second polarization orientation could have any respective orientations, so long as the difference between the two orientations allows the first projected light stream 16 and the second projected light stream 20 to be separated from one another by a pair of polarized lenses. While for purposes of illustration, two projectors 12-1, 12-2 are utilized to generate the first projected light stream 16 and the second projected light stream 20, respectively, in other embodiments a single projector 12 may be utilized in conjunction with downstream optical elements such as a splitter to generate the first projected light stream 16 and the second projected light stream 20. Thus, a first projective element that projects the first projected light stream 16 may comprise simply the first projector 12-1, or a combination of a projector 12 and one or more elements configured to generate the first projected light stream 16, and a second projective element that projects the second projected light stream 20 may comprise simply the second projector 12-2, or may comprise the same projector 12 used to generate the first projected light stream 16 and one or more elements configured to generate the second projected light stream 20.

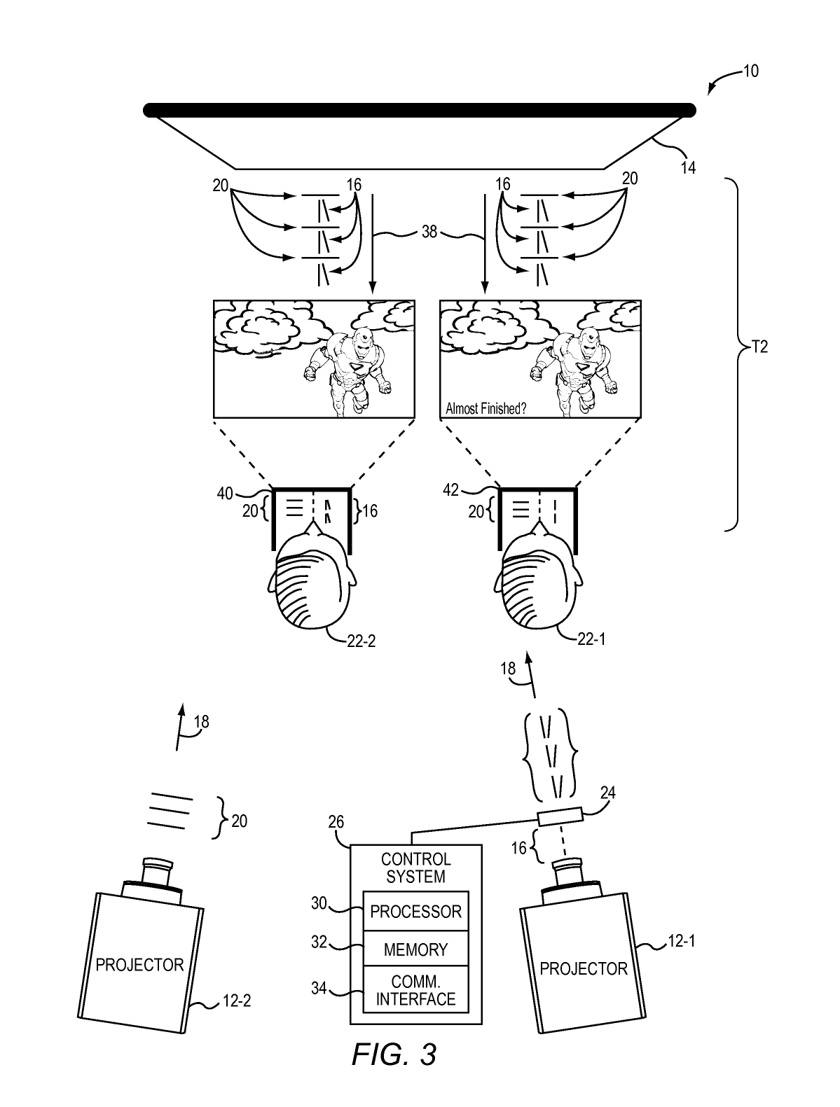

Details of embodiments will now be discussed in conjunction with two time periods: a first time period T1, which is illustrated in FIG. 1, and a second time period illustrated in FIG. 3. FIG. 1 will discuss the transmission, or projection of light from the projectors 12 to the screen 14.

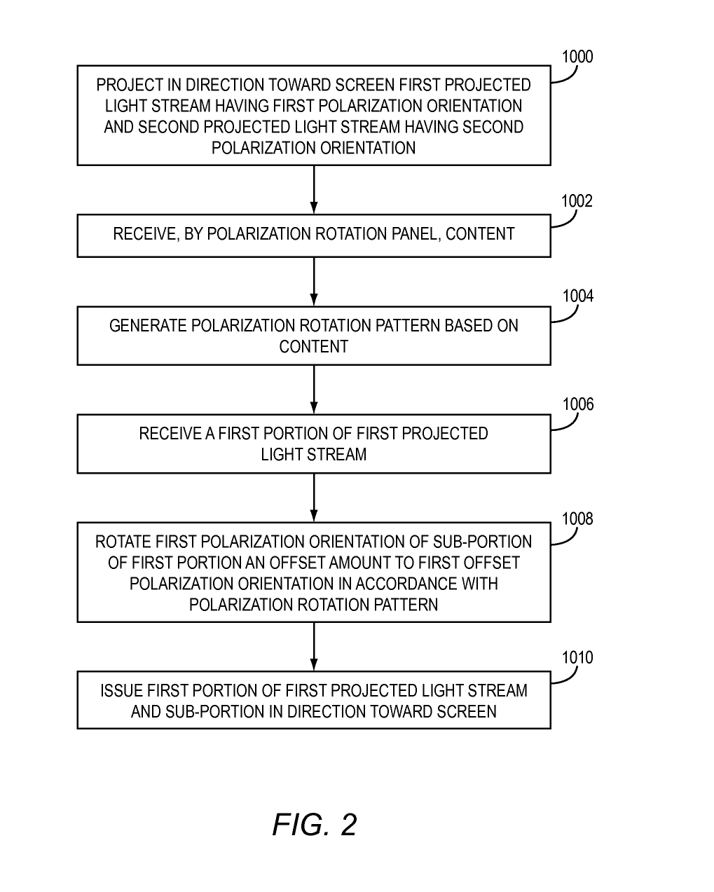

FIG. 2 is a flowchart of a method according to one embodiment and will be discussed in conjunction with FIG. 1. As discussed above, the first projector 12-1 projects the first projected light stream 16 that has the first polarization orientation in the direction 18 toward the screen 14, and the second projector 12-2 projects the second projected light stream 20 that has the second polarization orientation in the direction 18 toward the screen 14 (FIG. 2, block 1000).

A transparent polarization rotation panel 24 is disposed in the path between the first projector 12-1 and the screen 14. The polarization rotation panel 24 includes an array of liquid crystal display (LCD) elements that can be individually selected to rotate light passing through the individual LCD element an offset amount. The polarization rotation panel 24 includes a control system 26 that obtains content 28 that is to be added to the program being projected by the first projector 12-1 (FIG. 2, block 1002). In this example, the content 28 comprises subtitles, and specifically the subtitled text “ALMOST FINISHED?,” but the embodiments are not limited to adding subtitles to projected programs, and the content 28 may comprise any additional content or information. Non-limiting examples of additional content include news, weather reports, commercials and/or advertising, and games for children.

The control system 26 includes a processor 30, a memory 32, and a communications interface 34. The polarization rotation panel 24 may receive the content from another device, such as a device providing the program to the first projector 12-1, or the content may be stored in a storage (not illustrated) of the polarization rotation panel 24. The polarization rotation panel 24 generates a polarization rotation pattern based on the content (FIG. 2, block 1004). The polarization rotation panel 24 also receives a first portion of the first projected light stream 16. The first portion may be the entire first projected light stream 16 or less than the entire first projected light stream 16.

The polarization rotation panel 24 rotates a first polarization orientation of a sub-portion of the first portion of the first projected light stream 16 an offset amount to a first offset polarization orientation in accordance with the polarization rotation pattern (FIG. 2, block 1008). In one embodiment, this encodes the sub-portion of the first portion of the first projected light stream 16 with the content in a manner such that the content is invisible to an unaided eye of a human. The sub-portion of the first portion of the first projected light stream 16 may also be referred to herein as a second portion of the first projected light stream 16. In essence, the polarization orientation of some of the light received by the polarization rotation panel 24 remains unchanged as it passes through the polarization rotation panel 24, and the polarization orientation of some of the light is rotated an offset amount. In this example, the offset amount is 10 degrees, and first offset polarization orientation is 100 degrees, as illustrated by inset 36. The polarization rotation panel 24 then issues the first portion of the first projected light stream 16 and the sub-portion of the first projected light stream 16 in the direction 18 toward the screen 14 (FIG. 2, block 1010). Notably, the entire first projected light stream 16, after being issued by the polarization rotation panel 24, comprises the content of the program that was issued by the first projector 12-1, and only the sub-portion of the first projected light stream 16 that was received by the polarization rotation panel 24 has been further rotated by 10 degrees in a pattern that is based on the content 28. This process happens continually as the first projector 12-1 continually projects the first projected light stream 16 in the direction 18 toward the screen 14.

The system 10 may include a number of additional optical elements that have not been illustrated for purposes of clarity. For example, imaging optics may be provided between an output of the first projector 12-1 and the polarization rotation panel 24 in order to create an intermediate focal plane at the location of the polarization rotation panel 24. Additional imaging optics may be placed between the polarization rotation panel 24 and the screen 14 in order to image the first projected light stream 16 that is issued by the polarization rotation panel 24 to the screen 14.

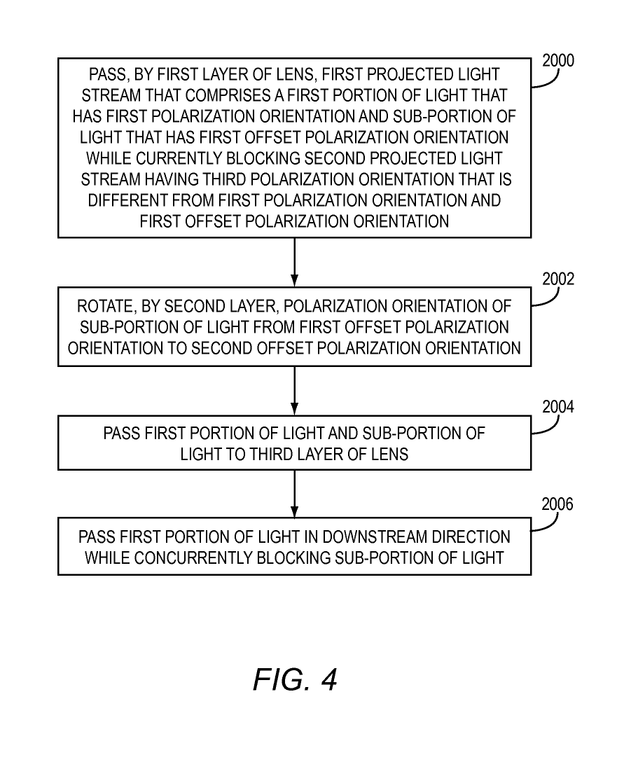

FIG. 3 is a block diagram of the system 10 illustrated in FIG. 1 during a second time period T2. FIG. 4 is a flowchart of a method according to one embodiment and will be discussed in conjunction with FIG. 3. The first projected light stream 16 and the second projected light stream 20 concurrently impact the screen 14 and are both reflected in a downstream direction 38 toward both the viewers 22.

The viewer 22-2 is wearing normal polarized glasses 40, such that one lens, in this example, the left lens, blocks light having the first polarization orientation and passes light having the second polarization orientation. Thus, the left lens blocks the first projected light stream 16 and passes the second projected light stream 20 to the left eye of the viewer 22-2. The right lens of the polarized glasses 40 blocks light having the second polarization orientation, and passes light having the first polarization orientation. Thus the right lens blocks the second projected light stream 20 and passes the first projected light stream 16 to the right eye of the viewer 22-2.

Notably, polarized lenses will pass not only light having a particular polarization orientation, but also will pass light having a polarization orientation that is near the particular polarization orientation. As the polarization orientation of light gets farther and farther from the particular polarization orientation that a lens is designed to pass, the intensity of the light diminishes. For example, a 5 degree polarization orientation difference results in a 0.7 percent reduction in intensity; a 10 degree polarization orientation results in a 3 percent reduction in intensity; and a 20 degree polarization orientation difference results in an 11.7 percent reduction in intensity. Consequently, the viewer 22-2 sees little or no visual distinction between the first projected light stream 16 that has the first polarization orientation and the sub-portion of the first projected light stream 16 that has the first offset polarization orientation. Thus, the rotation imparted on the sub-portion of the first projected light stream 16 has no visual effect to the viewer 22-2.

The viewer 22-1 is wearing glasses 42 according to one embodiment. In this embodiment, the glasses 42 have one lens, in this example the left lens, that blocks light having the first polarization orientation, and passes light having the second polarization orientation. Thus, the left lens blocks the first projected light stream 16 and passes the second projected light stream 20 to the left eye of the viewer 22-2.

The right lens of the glasses 42 is a multi-layer lens. The first layer of the lens passes to a second layer of the lens the first projected light stream 16 and concurrently blocks the second projected light stream 20 (FIG. 4, block 2000). The second layer rotates the polarization orientation of the sub-portion of the first projected light stream 16 from the first offset polarization orientation to a second offset polarization orientation (FIG. 4, block 2002). The second offset polarization orientation is preferably substantially different from the first offset polarization orientation, such as in a range between about 70 degrees to about 110 degrees with respect to the first polarization orientation. The second layer passes the first portion of the first projected light stream 16 and the sub-portion of the first projected light stream 16 to a third layer of the lens (FIG. 4, block 2004). The third layer passes the first portion of the first projected light stream 16 in the downstream direction 38 toward the right eye of the viewer 22-1, and blocks the sub-portion of the first projected light stream 16. Thus, the viewer 22-1 is presented the first projected light stream 16 absent the light that made up the sub-portion whose polarization orientation was rotated the offset amount by the polarization rotation panel 24. The viewer 22-1 thus sees an absence of light in the polarization rotation pattern.

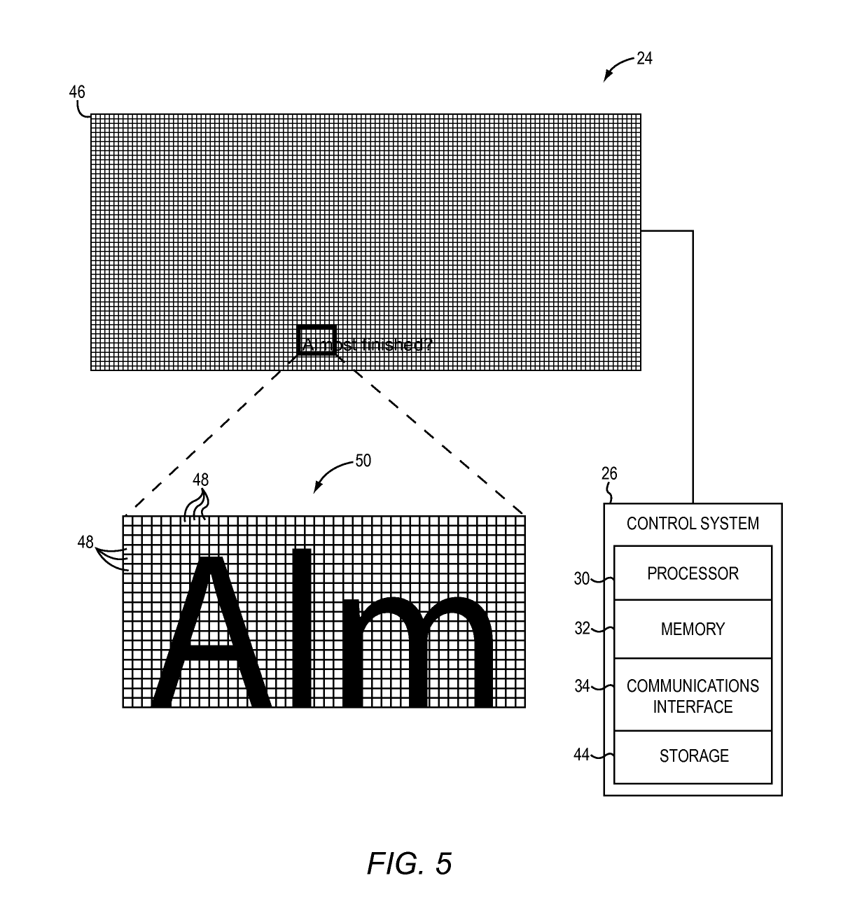

FIG. 5 is a block diagram of the polarization rotation panel 24 according to one embodiment. The polarization rotation panel 24 comprises the control system 26, which, as discussed previously, is configured to obtain the content 28 and generate a polarization rotation pattern based on the content 28. The content 28 can be provided to the polarization rotation panel 24 via an external device, for example, the communications interface 34, in synchronicity with the content 28 being projected toward the screen 14. Alternatively, the polarization rotation panel 24 may obtain the content 28 from a storage 44 which may comprise, for example, a hard-drive or optical media such as a digital versatile disk (DVD) or compact disk (CD).

The polarization rotation panel 24 comprises a transparent array 46 of LCD elements 48. In one embodiment, each LCD element 48 comprises at least one pixel. For purposes of illustration, only a few LCD elements 48 have been individually labeled. The array 46 has a predetermined resolution defined by the number of columns of LCD elements 48 and the number of rows of LCD elements 48. The resolution illustrated in FIG. 5 is solely for purposes of illustration, and in practice, the resolution of the polarization rotation panel 24 may be substantially greater, or less. The size of the array 46 may also differ based on the distance of the array 46 from the first projector 12-1, or the distance of the array 46 from an imaging optic used to create an intermediate focal plane between an output of the first projector 12-1 and the screen 14.

If the array 46 is utilized without any imaging optics, then the closer the array 46 is to the output of the first projector 12-1, the smaller the array 46 may be. If imaging optics are utilized to create an intermediate focal plane, then the farther the array 46 is from the output of the first projector 12-1, the smaller the array 46 may be. In one embodiment, the array 46 is about 1.9 inches in width and height, and has a horizontal and vertical resolution of about 160 LCD elements 48, and each LCD element 48 is about 300 micrometers in width and height. The array 46, in this embodiment, is positioned about 1.5 inches from a first imaging optic which is located immediately adjacent to an output of the first projector 12-1, and which creates an intermediate focal plane at such location. A second imaging optic is located about 2 inches downstream of the array 46 and images the output of the first projected light stream 16 that is issued from the array 46. The first imaging optic may comprise any lens or system of lens suitable for creating an intermediate focal plane between the output of the first projector 12-1 and the screen 14, and the second imaging optic may comprise any lens or system of lens suitable for imaging the output of the array 46 to the screen 14.

At least some of the LCD elements 48 have multiple modes, including a non-rotation mode and a rotation mode. In one embodiment, the non-rotation mode is associated with an OFF state of an LCD element 48, and the rotation mode which is associated with an ON state of the LCD element 48. When in the non-rotation mode, the polarization orientation of light passing through a respective LCD element 48 remains substantially unchanged. When in the rotation mode, the polarization orientation of light passing through the respective LCD element 48 is rotated an offset amount to the first offset polarization orientation. The offset amount that an LCD element 48 rotates the light when in the rotation mode may be fixed, to reduce costs, or may be programmable.

As discussed above, the offset amount is sufficient such that the second layer of the glasses 42 worn by the viewer 22-1 can further rotate the polarization orientation of such light with respect to the first polarization orientation, but preferably is not so great that the viewer 22-2 can discern any difference between light having the first polarization orientation and light having the first offset polarization orientation. In one embodiment, the offset amount is in a range between about 5 degrees to about 30 degrees with respect to the first polarization orientation. In one embodiment, the offset amount is an amount in a range between about 10 degrees to about 15 degrees with respect to the first polarization orientation.

The control system 26 obtains the content 28, in this example the text “Almost Finished?,” and then generates a polarization rotation pattern based on the content 28. In one embodiment, the control system 26 identifies a group of LCD elements 48 of the array 46 that, based on desired viewing characteristics of the content 28 on the screen 14, such as height and width, form a pattern that replicates the content 28. FIG. 5 illustrates an enlarged portion 50 of the array 46 to illustrate the mapping by the control system 26 of three letters of the content 28, “Alm,” to the array 46 of LCD elements 48 to identify those LCD elements 48 for replicating the letters “Alm.” As discussed above, due to the limitations of drawings, the resolution illustrated may be substantially less than that used in practice.

After the group of LCD elements 48 is identified, and consistent with any timing requirements of adding the content 28 to the projected program, the control system 26 sets the group of LCD elements 48 in the array 46 to the rotation mode. The polarization orientation of light from the sub-portion of the first projected light stream 16 that passes through such LCD elements 48 is then rotated the offset amount to give such sub-portion the first offset polarization orientation. Because the content 28 is conveyed through a polarization orientation, the content 28 is invisible to an unaided eye of a human. Iteratively, over a period of time, such as the duration of the program, this process repeats. Thus, the control system 26 receives new content 28, determines a new group of LCD elements 48 that form a new polarization rotation pattern based on the new content 28, sets all the LCD elements 48 in the array 46 to the non-rotation mode to erase the previous polarization rotation pattern, and then sets the LCD elements 48 in the new group of LCD elements 48 to the rotation mode. The timing for the continual presentation of new content 28 in lieu of previous content 28 may be provided separately from the content 28, or may be implied simply by the presence of new content 28.

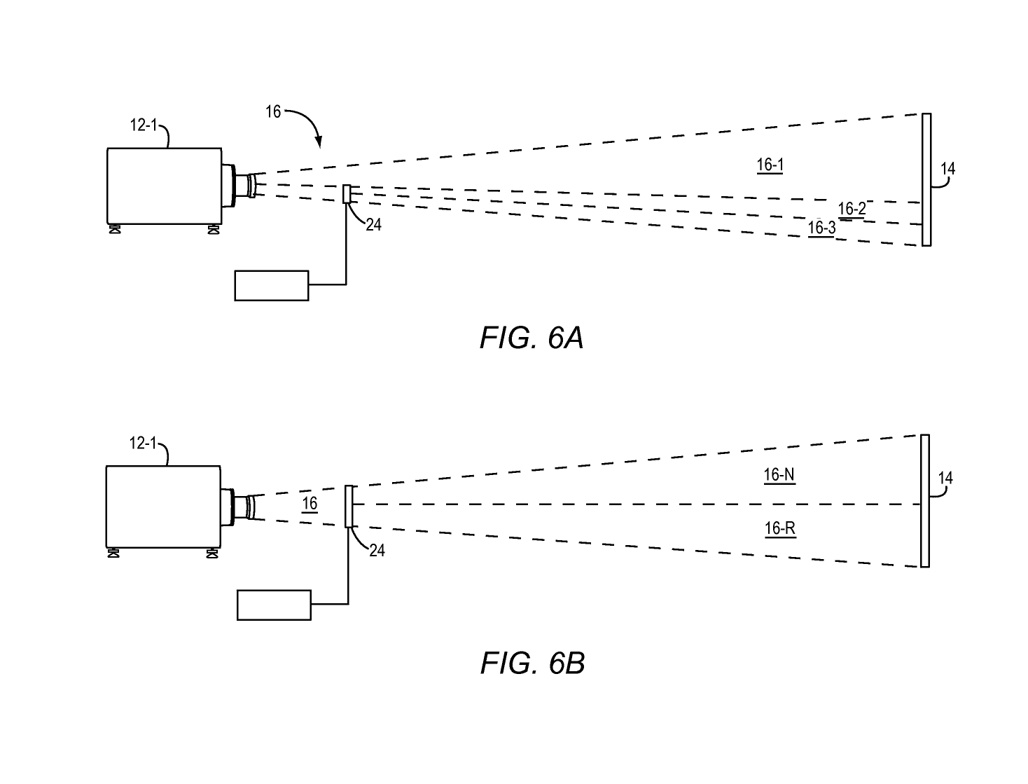

FIGS. 6A and 6B are block diagrams illustrating two different embodiments of the polarization rotation panel 24. FIG. 6A illustrates an embodiment where the portion of the first projected light stream 16 that passes through the polarization rotation panel 24 is less than all of the first projected light stream 16. In this embodiment, a portion 16-1 completely bypasses the polarization rotation panel 24. A portion 16-2 passes through LCD elements 48 of the polarization rotation panel 24 in the non-rotation mode, and the polarization orientation remains unchanged. A portion 16-3 passes through LCD elements 48 of the polarization rotation panel 24 in the rotation mode, and the polarization orientation is rotated the offset amount to the first offset polarization orientation.

FIG. 6B illustrates an embodiment where the portion of the first projected light stream 16 that passes through the polarization rotation panel 24 is all of the first projected light stream 16. In this embodiment, a portion 16-N passes through LCD elements 48 of the polarization rotation panel 24 in the non-rotation mode, and the polarization orientation remains unchanged. A portion 16-R passes through LCD elements 48 of the polarization rotation panel 24 in the rotation mode, and the polarization orientation is rotated the offset amount to the first offset polarization orientation.

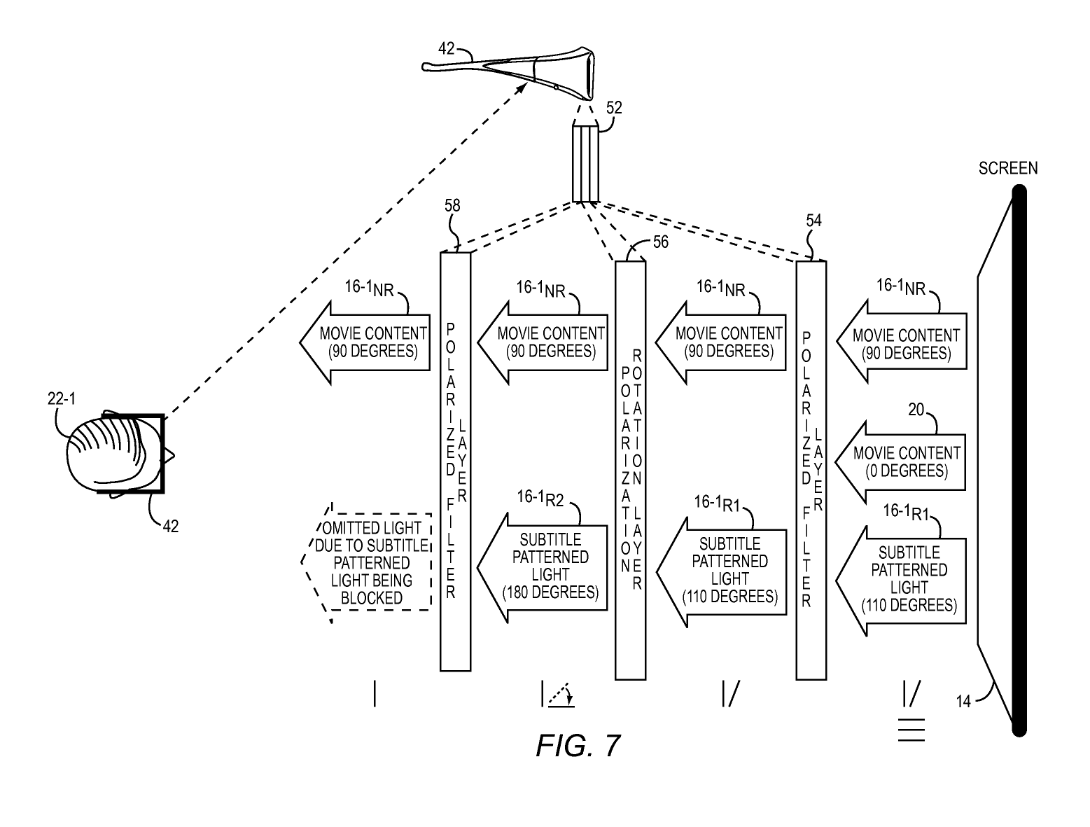

FIG. 7 is a block diagram of a multi-layer lens 52 of the glasses 42 according to one embodiment. The lens 52 corresponds to the right lens of the glasses 42 illustrated in FIGS. 1 and 3. A first layer 54 comprises a polarized filter layer. The first layer 54 is configured to pass, toward a second layer 56, the first projected light stream 16. The first projected light stream 16 comprises a first portion of light 16-1_{NR} having a first polarization orientation and a sub-portion of light 16-1_{R} having a first offset polarization orientation, as discussed above. The first layer 54 is further configured to concurrently block the second projected light stream 20, which has a third polarization orientation that is different from the first polarization orientation and the first offset polarization orientation.

The second layer 56 comprises a polarization rotation layer that is configured to rotate the polarization orientation of the sub-portion of light 16-1_{R1} from the first offset polarization orientation to a second offset polarization orientation. In particular, the sub-portion of light 16-1_{R1} is rotated with respect to the first portion of light 16-1_{NR} such that the second offset polarization orientation is substantially different from the first polarization orientation. In one embodiment, the second offset polarization orientation is in a range between about 70 degrees to about 110 degrees with respect to the first polarization orientation. In another embodiment, the second offset polarization orientation is about 90 degrees with respect to the first polarization orientation. In one embodiment, the second layer 56 rotates the sub-portion of light 16-1_{R1} from the first offset polarization orientation to a second offset polarization orientation by altering the optical path length of the sub-portion of light 16-1_{R1} with respect to the optical path length of the first portion of light 16-1_{NR}. The second layer 56 may comprise any material suitable for altering the polarization orientation of one portion of light having a first polarization orientation with respect to another portion of light having a different polarization orientation. In one embodiment, the second layer 56 may comprise a multi-layer second layer 56, and may comprise, for example, two variable phase shifters in a row (such as two variable phase retarders) that have optical axes orientated respectively parallel and horizontal to the first portion of light 16-1_{NR}. In such embodiment, the sub-portion of light 16-1_{R1} will change its polarization orientation because it has a certain angle with respect to the two optical axes. Through the use of two variable phase retarders, any point on the Poincaré sphere (every polarization orientation) may be selected.

The sub-portion of light 16-1_{R1} will be referred to herein subsequently as the sub-portion of light 16-1_{R2} to illustrate that the polarization orientation of the light has changed. The second layer 56 passes the first portion of light 16-1_{NR} and the sub-portion of light 16-1_{R2} to a third layer 58 of the lens 52. The third layer 58 is a polarized filter layer and is configured to pass the first portion of light 16-1_{NR} in a downstream direction toward an eye of the viewer 22-1 and to concurrently block the sub-portion of light 16-1_{R2}. Thus, the eye of the viewer 22-1 is presented with the first portion of light 16-1_{NR}, which comprises movie content, and the sub-portion of light 16-1_{R2} is blocked, resulting in an absence of light in a pattern of the polarization rotation pattern. This is perceived by the viewer 22-1 as the content 28.

While the embodiments are described with respect to a particular attribute of light, in particular polarization orientation, the embodiments are not limited to that particular attribute, and have applicability to other attributes of light, such as phase. Thus, in one embodiment, the phase of the first projected light stream 16 may be modulated in accordance with a pattern that replicates the content 28.

While for purposes of illustration the embodiments have been disclosed in the context of utilizing the polarization rotation panel 24 with only the first projected light stream 16, in other embodiments, both the first projected light stream 16 and the second projected light stream 20 may pass through the polarization rotation panel 24. Moreover, while for purposes of illustration, two projectors 12-1, 12-2 are utilized to generate the first projected light stream 16 and the second projected light stream 20, respectively, in other embodiments a single projector 12 may be utilized in conjunction with downstream optical elements such as a splitter to generate and separate the first projected light stream 16 and the second projected light stream 20.

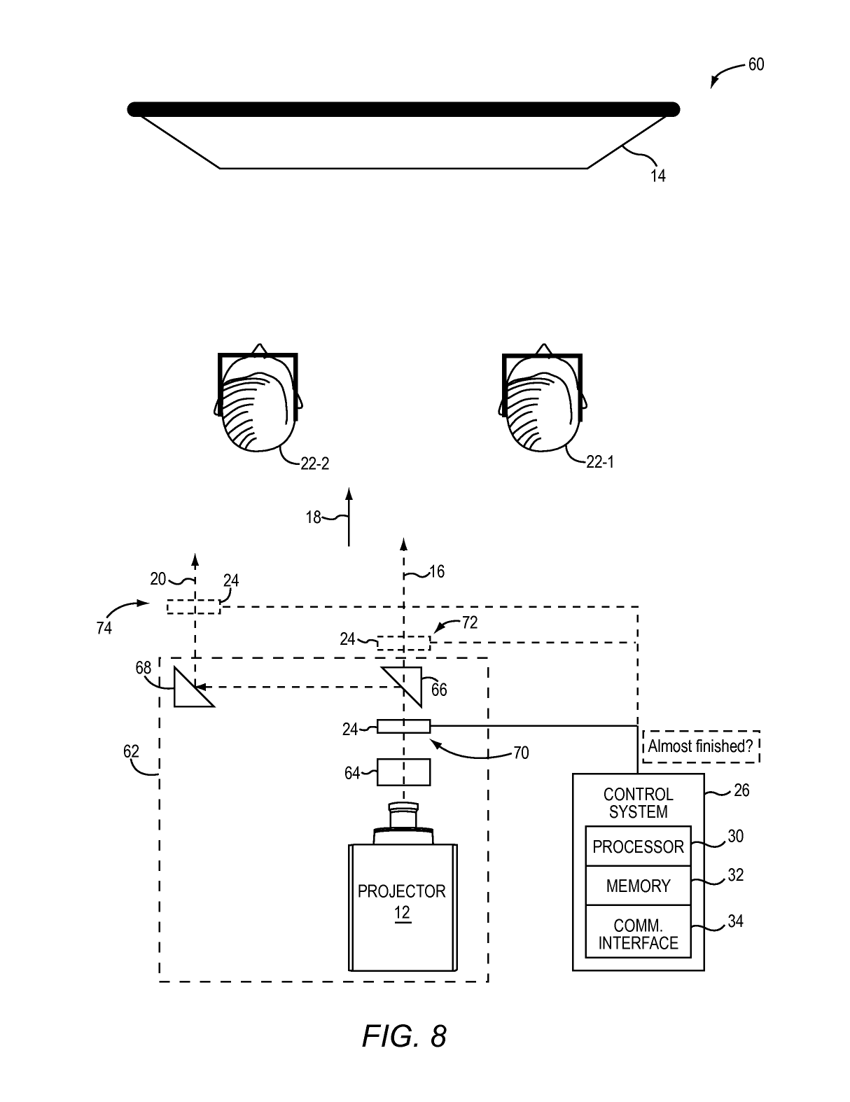

FIG. 8 is a block diagram of a system 60 in which embodiments may be practiced according to a single projector embodiment. In this embodiment, a projective system 62 comprising a single projector 12 is configured to generate the first projected light stream 16 and the second projected light stream 20. The projective system comprises a single projector 12 that continuously projects alternating images, such that one image in the alternating sequence is destined for a right eye of a viewer 22, and the other image in the alternating sequence is destined for the left eye of the viewer 22. A polarizer 64 is synchronized with the alternating projected output of the projector 12, and polarizes the images destined for the right eye to have the first polarization orientation, and polarizes the images destined for the left eye to have the second polarization orientation. A polarization sensitive mirror 66 receives the output of the polarizer 64 and passes a first projected light stream 16 in the direction 18 toward the screen 14, and reflects the second projected light stream 20 toward a reflector 68. The reflector 68 reflects the second projected light stream 20 in the direction 18 toward the screen 14. It will be appreciated that the use of the polarization sensitive mirror 64 and the reflector 66 are simply one mechanism for separating the first and second projected light streams 16, 20 that are output from the projector 12, and that other arrangements of optical elements could be utilized to accomplish the same goal.

The polarization rotation panel 24 may be located at any of several locations, including at a location 70 that is subsequent to the polarizer 64 and prior to the polarizing mirror 66, at a location 72 subsequent to the polarizing mirror 66 such that only the first projected light stream 16 passes through the polarization rotation panel 24, and/or at a location 74 such that only the second projected light stream 20 passes through the polarization rotation panel 24. In one embodiment, polarization rotation panels 24 may be placed at both locations 72 and 74 such that both the first projected light stream 16 passes through a polarization rotation panel 24 and the second projected light stream 20 passes through a polarization rotation panel 24. In embodiments in which both the first projected light stream 16 passes through a polarization rotation panel 24 and the second projected light stream 20 passes through a polarization rotation panel 24, such as when the polarization rotation panel 24 is positioned at location 70, or polarization rotation panels 24 are positioned at both locations 72 and 74, both lenses of the viewer 22-1 may comprise a multi-layer lens 52 as discussed above with regard to FIG. 7.

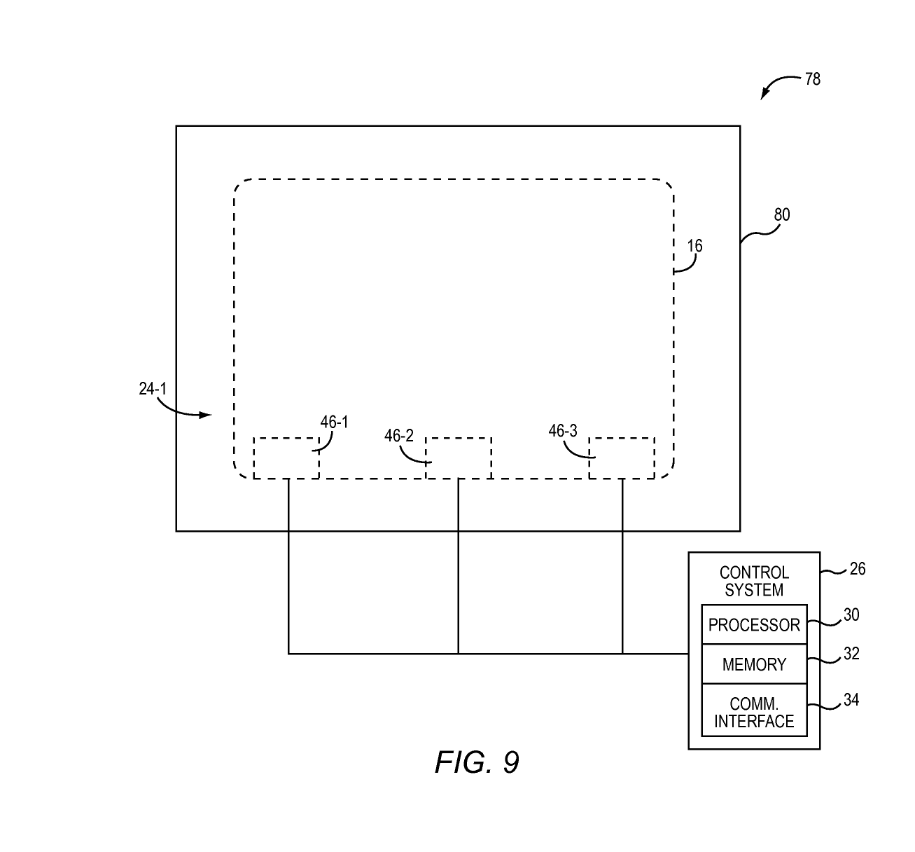

FIG. 9 is a block diagram of a system 78 according to another embodiment. In this embodiment, a transparent polarization rotation panel 24-1 comprises one or more LCD arrays 46-1, 46-2, 46-3 (generally LCD arrays 46) that are positioned by a transparent window 80 through which the first projected light stream 16 passes. That portion of the window 80 that does not contain one of the one or more LCD arrays 46 passes the first projected light stream 16 unaltered.

Although the LCD arrays 46 are illustrated as being positioned within the transparent window 80 such that a bottom portion of the first projected light stream 16 passes through the LCD arrays 46, it is apparent that the LCD arrays 46 may be positioned at any desired location within the window 80 such that additional content, including subtitles, may be presented at any desired location on the screen 14.

One use of multiple LCD arrays 46 is for the presentation of a plurality of different subtitles, such as subtitles in multiple different languages, to thereby accommodate different viewers who may speak different languages, while watching the same movie. Each LCD array 46 may have a different offset polarization orientation that is matched to a corresponding pair of glasses 42. The LCD array 46-1 comprises a first array of LCD elements 48, at least some of the LCD elements 48 having a non-rotation mode and a first rotation mode that rotates the first polarization orientation of a first sub-portion of the first projected light stream 16 a first offset amount, such as, for example, 10 degrees, to a first offset polarization orientation. The LCD array 46-2 comprises a second array of LCD elements 48, at least some of the LCD elements 48 having the non-rotation mode and a second rotation mode that rotates the first polarization orientation of a second sub-portion of the first projected light stream 16 a second offset amount, such as, for example, 20 degrees, to a second offset polarization orientation. The LCD array 46-3 comprises a third array of LCD elements 48, at least some of the LCD elements 48 having the non-rotation mode and a third rotation mode that rotates the first polarization orientation of a third sub-portion of the first projected light stream 16 a third offset amount, such as, for example, 30 degrees, to a third offset polarization orientation.

In operation, the control system 26 is coupled to the LCD arrays 46. The control system 26 receives a first subtitle in a first language, determines a first group of LCD elements 48 of the LCD array 46-1 that forms a first polarization rotation pattern based on the first subtitle, and sets the LCD elements 48 in the LCD array 46-1 to the first rotation mode. Substantially concurrently therewith, the control system 26 may receive a second subtitle in a second language, determine a second group of LCD elements 48 of the LCD array 46-2 that forms a second polarization rotation pattern based on the second subtitle, and set the LCD elements 48 in the LCD array 46-2 to the second rotation mode. The control system 26 may receive a third subtitle in a third language, determine a third group of LCD elements 48 of the LCD array 46-3 that forms a third polarization rotation pattern based on the third subtitle, and set the LCD elements 48 in the LCD array 46-3 to the third rotation mode.

Each viewer 22 wears a pair of glasses 42 that is matched to a corresponding LCD array 46, such that each viewer 22 only sees the subtitles that are processed by the respective pair of glasses 42. Because the subtitles are encoded via polarization, the subtitles are completely invisible to the unaided eye of a human.

Those skilled in the art will recognize improvements and modifications to the preferred embodiments of the disclosure. All such improvements and modifications are considered within the scope of the concepts disclosed herein and the claims that follow.

What is claimed is:

1. A method for adding content to a light stream, comprising:
receiving, by a polarization rotation panel comprising a processor, content;
generating a polarization rotation pattern based on the content;
receiving at least a first portion of a first projected light stream, the at least the first portion having a first polarization orientation;
rotating the first polarization orientation of a sub-portion of the at least the first portion an offset amount to a first offset polarization orientation in accordance with the polarization rotation pattern; and
issuing the at least the first portion of the first projected light stream and the sub-portion in a downstream direction.

2. The method of claim 1, wherein the polarization rotation panel comprises an array of liquid crystal display (LCD) elements, at least some of the LCD elements having a non-rotation mode and a rotation mode.

3. The method of claim 2, wherein generating the polarization rotation pattern based on the content further comprises:
determining a group of LCD elements that form the polarization rotation pattern based on the content; and
setting the LCD elements in the group of LCD elements to the rotation mode.

4. The method of claim 3, further comprising:
iteratively, over a period of time:
receiving new content;
setting the LCD elements in the array to the non-rotation mode;
determining a new group of LCD elements that form a new polarization rotation pattern based on the new content; and
setting the LCD elements in the new group of LCD elements to the rotation mode.

5. The method of claim 1, wherein the first projected light stream comprises a movie and the content comprises subtitles.

6. The method of claim 5, wherein the subtitles are invisible to an unaided eye of a human.

7. The method of claim 1, wherein the polarization rotation pattern replicates the content.

8. The method of claim 1, wherein the offset amount is in a range between about 5 degrees to about 20 degrees with respect to the first polarization orientation.

9. A polarization rotation panel, comprising:
an array of liquid crystal display (LCD) elements, at least some of the LCD elements having a non-rotation mode and a rotation mode; and
a processor coupled to the array of LCD elements and configured to:
receive content;
determine a group of LCD elements that form a polarization rotation pattern based on the content; and
set the LCD elements in the group of LCD elements to the rotation mode.

10. The polarization rotation panel of claim 9, wherein the processor is further configured to:
iteratively, over a period of time:
receive new content;
set the LCD elements in the array to the non-rotation mode;
determine a new group of LCD elements that form a new polarization rotation pattern based on the new content; and
set the LCD elements in the new group of LCD elements to the rotation mode.

11. The polarization rotation panel of claim 9, wherein each LCD element of the array of LCD elements that is in the non-rotation mode is configured to:
receive at least a first portion of a projected light stream having a polarization orientation;
transmit the at least the first portion of the projected light stream without altering the polarization orientation; and
wherein each LCD element of the array of LCD elements that is in the rotation mode is configured to:
receive a second portion of the projected light stream having the polarization orientation;
rotate the polarization orientation of the second portion of the projected light stream an offset amount to an offset polarization orientation; and
transmit the second portion of the projected light stream of the projected light stream.

12. The polarization rotation panel of claim 11, wherein the projected light stream comprises a movie and the content comprises subtitles.

13. The polarization rotation panel of claim 12, wherein the subtitles are invisible to an unaided eye of a human.

14. The polarization rotation panel of claim 12, wherein the projected light stream comprises a three-dimensional movie and the content comprises one of subtitles in a language spoken by a character in the movie, subtitles in a foreign language that differs from the language spoken by a character in the movie, supplemental text, and supplemental information.

15. The polarization rotation panel of claim 12, wherein the offset amount is in a range between about 5 degrees to about 20 degrees with respect to the offset polarization orientation.

16. The polarization rotation panel of claim 9, wherein the polarization rotation pattern replicates the content.

17. A method, comprising:
passing, by a first layer of a lens to a second layer of the lens, a first projected light stream that comprises a first portion of light having a first polarization orientation and a sub-portion of light having a first offset polarization orientation while concurrently blocking a second projected light stream having a third polarization orientation that is different from the first polarization orientation and the first offset polarization orientation;
rotating, by the second layer, a polarization orientation of the sub-portion of light from the first offset polarization orientation to a second offset polarization orientation;
passing the first portion of light and the sub-portion of light to a third layer of the lens; and
passing, by the third layer, the first portion of light in a downstream direction while concurrently blocking the sub-portion of light.

18. The method of claim 17, wherein the second offset polarization orientation is in a range between about 70 degrees to about 110 degrees with respect to the first polarization orientation.

19. The method of claim 17, wherein the second offset polarization orientation is about 90 degrees with respect to the first polarization orientation.

20. A multi-layer lens for use in glasses, comprising:
a first layer, a second layer, and a third layer;
wherein the first layer of the lens is configured to:
pass to the second layer a first projected light stream that comprises a first portion of light that has a first polarization orientation and a sub-portion of light having a first offset polarization orientation and concurrently block a second projected light stream having a third polarization orientation that is different from the first polarization orientation and the first offset polarization orientation;
wherein the second layer of the lens is configured to:
rotate a polarization orientation of the sub-portion of light from the first offset polarization orientation to a second offset polarization orientation; and
pass the first portion of light and the sub-portion of light to the third layer; and
wherein the third layer of the lens is configured to pass the first portion of light in a downstream direction and to concurrently block the sub-portion of light.

21. A method comprising:
projecting in a direction toward a screen a first projected light stream having a first polarization orientation and a second projected light stream having a second polarization orientation;
receiving, by a polarization rotation panel, content;
generating a polarization rotation pattern based on the content;
receiving at least a portion of the first projected light stream;
rotating the first polarization orientation of a sub-portion of the at least the portion of the first projected light stream an offset amount to a first offset polarization orientation in accordance with the polarization rotation pattern; and
issuing the at least the portion of the first projected light stream and the sub-portion in the direction toward the screen.

22. The method of claim 21, further comprising:
passing, by a first layer of a lens to a second layer of the lens, the first projected light stream while concurrently blocking the second projected light stream;
rotating, by the second layer, a polarization orientation of the sub-portion from the first offset polarization orientation to a second offset polarization orientation;
passing the at least the portion of the first projected light stream and the sub-portion to a third layer of the lens; and
passing, by the third layer, the at least the portion of the first projected light stream in a downstream direction while concurrently blocking the sub-portion.

23. A system comprising:
a projective system configured to project in a direction a first projected light stream having a first polarization orientation and a second projected light stream having a second polarization orientation; and
a polarization rotation panel comprising a processor configured to:
receive content;
receive a portion of the first projected light stream;
rotate the first polarization orientation of a sub-portion of the portion of the first projected light stream an offset amount to a first offset polarization orientation in accordance with a polarization rotation pattern; and
issue the portion of the first projected light stream and the sub-portion in the direction.

24. The system of claim 23, further comprising:
a lens comprising a first layer, a second layer, and a third layer;
wherein the first layer is configured to:
pass to the second layer the first projected light stream and concurrently block the second projected light stream;
wherein the second layer is configured to:
rotate a polarization orientation of the sub-portion from the first offset polarization orientation to a second offset polarization orientation; and
pass the portion of the first projected light stream and the sub-portion to the third layer; and
wherein the third layer is configured to pass the first portion of the first projected light stream in a downstream direction and to concurrently block the sub-portion.

25. A polarization rotation panel, comprising:
a first array of liquid crystal display (LCD) elements, at least some of the LCD elements having a non-rotation mode and a first rotation mode;
a second array of LCD elements, at least some of the LCD elements having the non-rotation mode and a second rotation mode; and
at least one processor coupled to the first array of LCD elements and the second array of LCD elements, and configured to:
receive a first subtitle in a first language;
determine a first group of LCD elements of the first array of LCD elements that form a first polarization rotation pattern based on the first subtitle;
set the LCD elements in the first group of LCD elements to the first rotation mode;
receive a second subtitle in a second language;
determine a second group of LCD elements of the second array of LCD elements that form a second polarization rotation pattern based on the second subtitle; and
set the LCD elements in the second group of LCD elements to the second rotation mode.

26. The polarization rotation panel of claim 25, wherein the first subtitle is encoded in the first polarization rotation pattern such that the first subtitle is invisible to an unaided eye of a human.

27. A system comprising:
a projective system configured to project in a direction a first projected light stream having a first polarization orientation and a second projected light stream having a second polarization orientation; and
a polarization rotation panel, comprising:
a first array of liquid crystal display (LCD) elements, at least some of the LCD elements having a non-rotation mode and a first rotation mode;
a second array of LCD elements, at least some of the LCD elements having the non-rotation mode and a second rotation mode; and
at least one processor coupled to the first array of LCD elements and the second array of LCD elements, and configured to:
receive a first subtitle in a first language;
determine a first group of LCD elements of the first array of LCD elements that form a first polarization rotation pattern based on the first subtitle;
set the LCD elements in the first group of LCD elements to the first rotation mode;
receive a second subtitle in a second language;
determine a second group of LCD elements of the second array of LCD elements that form a second polarization rotation pattern based on the second subtitle; and
set the LCD elements in the second group of LCD elements to the second rotation mode.

28. The system of claim 27, wherein the first subtitle is encoded in the first polarization rotation pattern such that the first subtitle is invisible to an unaided eye of a human.
